(19) United States
(12) Patent Application Publication
(10) Pub. No.: US 2013/0223067 A1
(43) Pub. Date: Aug. 29, 2013

(54) Luminaire

(71) Applicant: TOSHIBA LIGHTING & TECHNOLOGY CORPORATION, (US)

(72) Inventor: Kenichi Ito, Kanagawa-ken (JP)

(73) Assignee: TOSHIBA LIGHTING & TECHNOLOGY CORPORATION, Yokosuka-shi (JP)

(21) Appl. No.: 13/779,806

(22) Filed: Feb. 28, 2013

(30) Foreign Application Priority Data
Feb. 29, 2012 (JP) 2012-043003

(51) Int. Cl. F21V 19/02; F21V 11/00

(52) U.S. Cl. CPC F21V 19/02; F21V 11/00
USPC 362/235; 362/249.07

(57) ABSTRACT

According to one embodiment, a luminaire includes a main body including a light-source housing frame, a light source module provided on the inner side of the light-source housing frame and including a substrate and a plurality of light-emitting elements mounted on the substrate, and a fixture attached to the light source module. The fixture includes a locking section movable between a retaining position where the locking section projects from an end portion of the light source module and locks to the light-source housing frame to retain the light source module in the main body and a releasing position where the locking section is unlocked from the light-source housing frame to enable the light source module to separate from the main body.

### CROSS-REFERENCE TO RELATED APPLICATION

This application is based upon and claims the benefit of priority from Japanese Patent Application No.2012-043003, filed on Feb. 29, 2012; the entire contents of which are incorporated herein by reference.

### FIELD

Embodiments described herein relate generally to a luminaire in which a light-emitting element such as an LED (Light Emitting Diode) is used as a light source.

### BACKGROUND

There is known a system ceiling in which a luminaire, equipment, and the like are dropped in a ceiling frame assembled by bar-like members having a T-shape in section. The system ceiling makes it easy to add, replace, and remove the luminaire and the equipment and has a high degree of freedom of design.

As a light source for the luminaire assembled in the system ceiling, in recent years, an LED module is used. The LED module is fixed to a luminaire main body by screwing.

### BRIEF DESCRIPTION OF THE DRAWINGS

FIG. 1 is an external perspective view of a luminaire according to an embodiment;

FIG. 2 is an external perspective view of the luminaire;

FIG. 3 is a perspective view of a state in which a baffle member and an equipment plate are removed from FIG. 2;

FIG. 4 is a plan view of the luminaire shown in FIG. 3;

FIG. 5 is an end face diagram showing an arrangement relation between a light source module and the baffle member in the luminaire;

FIG. 6 is an enlarged perspective view of a portion where the light source module is locked to a main body;

FIG. 7 is a perspective view of a state in which the height of attachment of the light source module to the main body is changed;

FIG. 8 is a perspective view of the light source module;

FIG. 9 is a perspective view of a light source unit;

FIG. 10 is an enlarged perspective view of a part of the light source unit;

FIG. 11 is a disassembled perspective view of components excluding the light source unit in the light source module;

FIGS. 12A and 12B are perspective views of a fixture;

FIG. 13A is a perspective view of a guide member in the fixture;

FIG. 13B is a perspective view of a movable member in the fixture;

FIGS. 14A and 14B are enlarged side views of an end portion to which the fixture is attached in the light source module;

FIG. 15 is a perspective view of the baffle member;

FIG. 16 is an enlarged perspective view of an end portion to which the fixture is attached in the baffle member;

FIG. 17 is a perspective view of a baffle supporting section in the baffle member;

FIG. 18 is an enlarged sectional view of the baffle supporting section;

FIG. 19 is a perspective view of a baffle in the baffle member; and

FIG. 20 is an enlarged perspective view of a part of the baffle member.

### DETAILED DESCRIPTION

In general, according to one embodiment, a luminaire includes: a main body including a light-source housing frame; a light source module provided on the inner side of the light-source housing frame and including a substrate and a plurality of light-emitting elements mounted on the substrate; and a fixture attached to the light source module. The fixture includes a locking section movable between a retaining position where the locking section projects from an end portion of the light source module and locks to the light-source housing frame to retain the light source module in the main body and a releasing position where the locking section is unlocked from the light-source housing frame to enable the light source module to separate from the main body.

An embodiment is explained with reference to the drawings. In the drawings, the same components are denoted by the same reference numerals and signs.

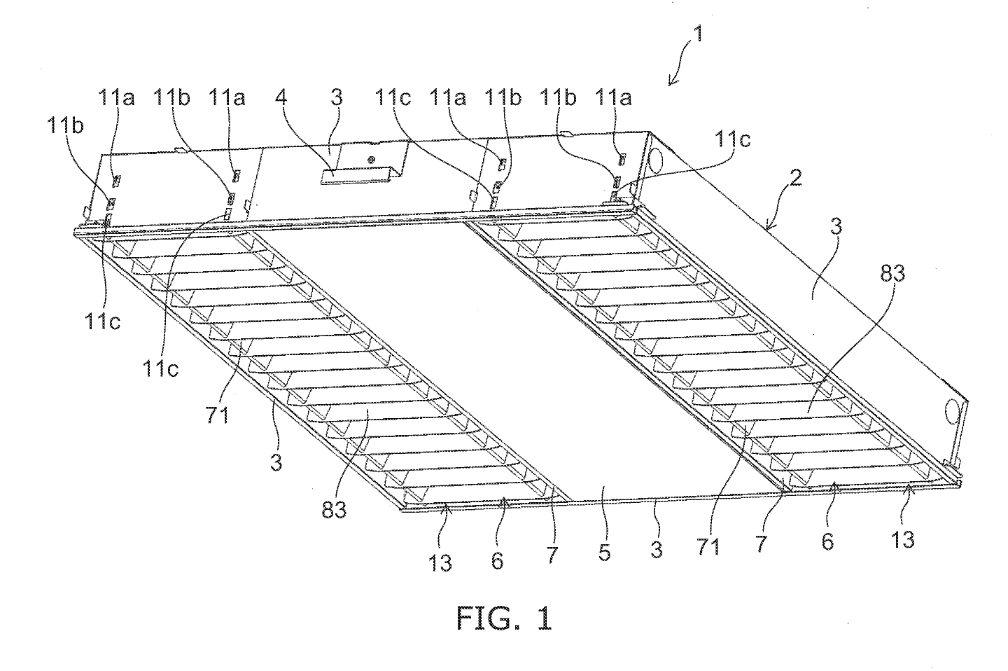

FIG. 1 is an external perspective view of a luminaire 1 according to an embodiment.

A surface on the lower side in a state shown in FIG. 1 is a light-emitting surface. The luminaire 1 is built in a system ceiling with the light-emitting surface faced down.

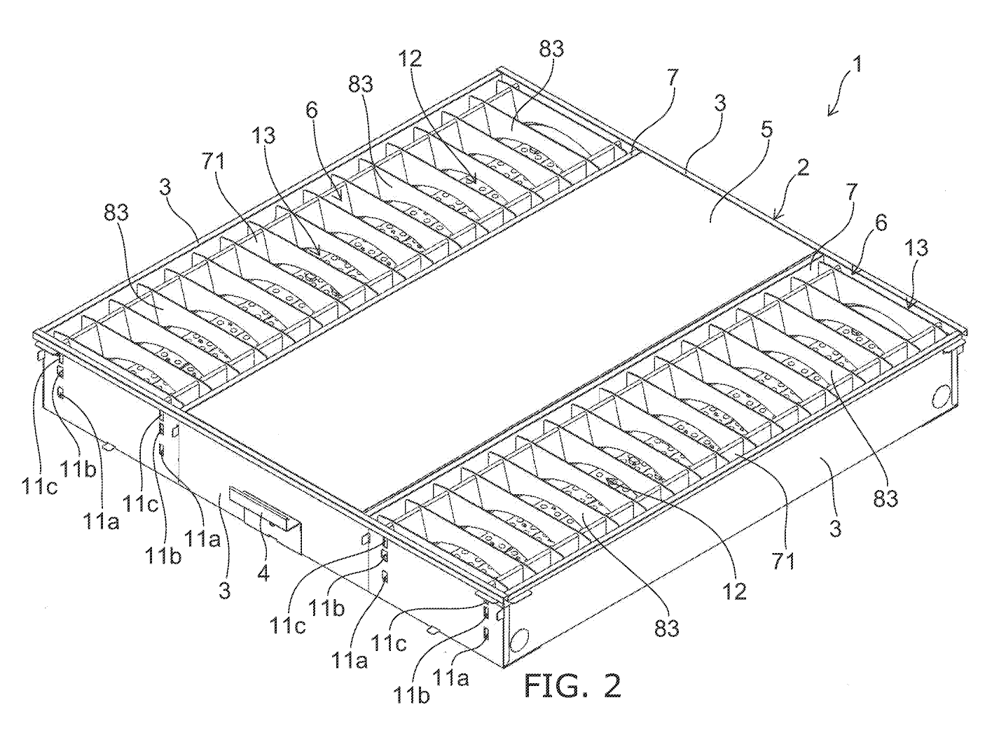

FIG. 2 is a perspective view of the luminaire 1 with the light-emitting surface side thereof faced up.

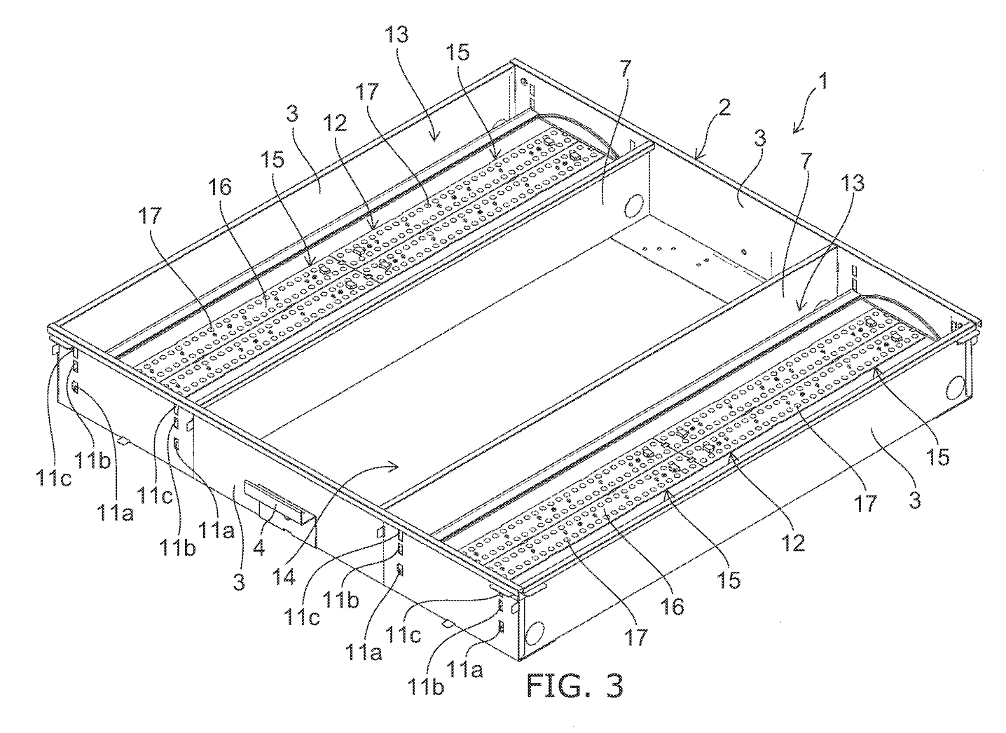

FIG. 3 is a perspective view of a state in which a baffle member 6 and an equipment plate 5 are removed from FIG. 2.

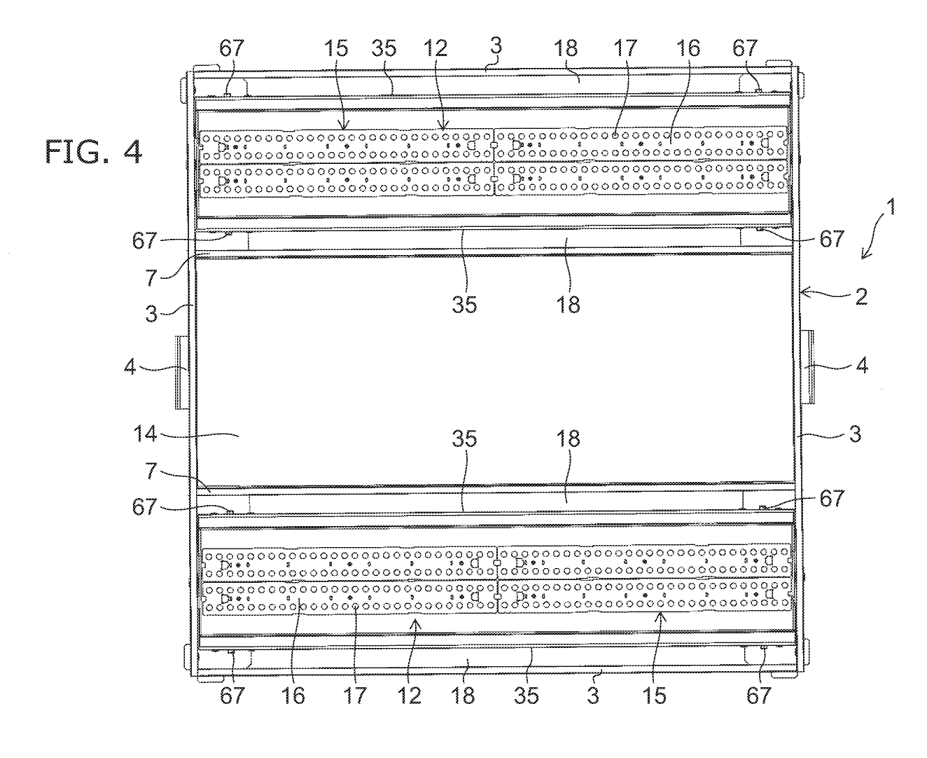

FIG. 4 is a plan view of the light-emitting surface side in the state shown in FIG. 3.

The luminaire 1 according to the embodiment includes a main body 2, light source modules 12, and baffle members 6. The main body 2 is attached to, for example, a frame assembled by bar-like members having a T-shape in section of the ceiling. The main body 2 is configured by combining a metal plate in a frame shape.

The light source modules 12 are housed on the inner side of the frame-like main body 2. The baffle members 6 are arranged on the light-emitting surface side of the light source modules 12 on the inner side of the main body 2.

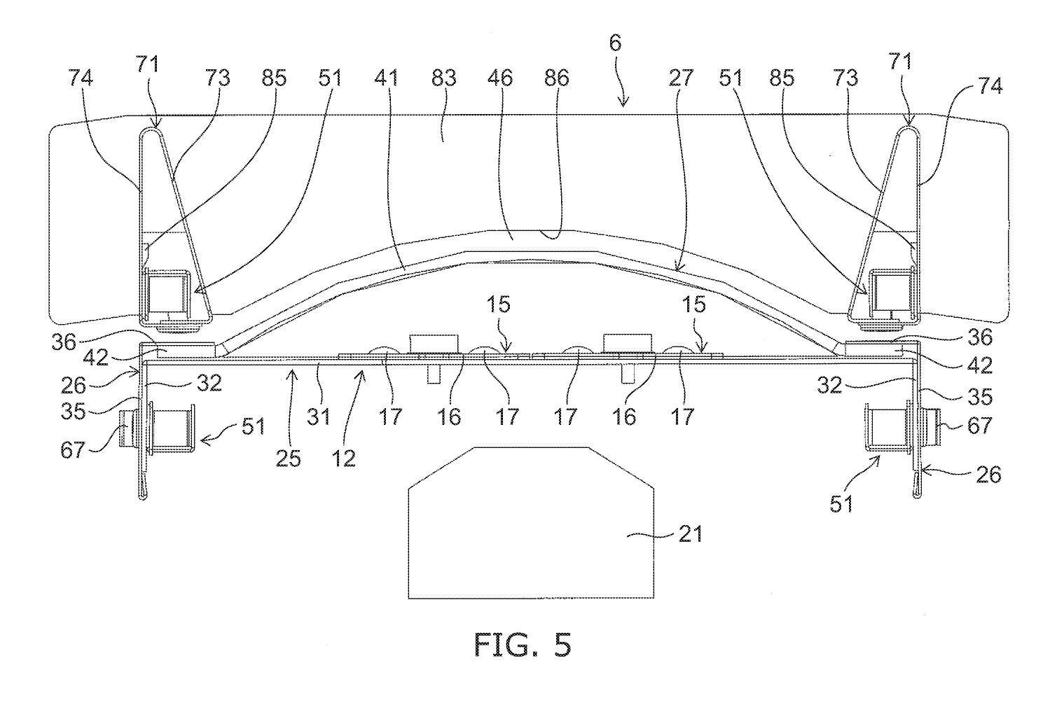

FIG. 5 is an end face diagram showing an arrangement relation between the light source modules 12 and the baffle members 6 in the main body 2. The light source modules 12 and the baffle members 6 are viewed from an end face side in the longitudinal direction thereof. In FIG. 5, the lower side is the ceiling side. Light-emitting surfaces of the light-source modules 12 face the opposite side of the ceiling (the upper side in FIG. 5).

As shown in FIGS. 3 and 4, the main body 2 includes, for example, four outer frames 3 combined in a square shape and inner frames 7 provided on the inner side of the outer frames 3. The inner side of the outer frames 3 is partitioned into three spaces by the two inner frames 7 extending in parallel.

Among the three spaces, two spaces are light source storing sections 13 in which the light-emitting modules 12 are housed. An equipment housing section 14, in which a speaker and the like are housed, is provided between the two light-source housing sections 13. An equipment plate 5 shown in FIGS. 1 and 2 is attached to an opening section on the opposite side of the ceiling in the equipment housing section 14.

A part of the outer frames 3 and the inner frames 7 surrounding the light-source housing section 13 are light-source housing frames. The light-source housing frames retain the light source module 12 via fixtures 51 explained below.

A plane shape of the light-source housing sections 13 is a rectangular shape. A plurality of locking holes 11a to 11c are formed as through-holes in a part of the outer frames 3 located at both the ends in the longitudinal direction of the light-source housing sections 13 and opposed to each other. Two locking holes formed at the same height are paired. For example, three pairs of the locking holes 11a to 11c are formed at different heights.

The locking hole 11a is formed in a position closest to the ceiling side. The locking hole 11c is formed in a side most distant from the ceiling. The locking hole 11b is formed between the locking hole 11a and the locking hole 11c. The locking holes 11a to 11c are formed in each of a pair of outer frames 3 opposed at both the ends in the longitudinal direction of the light-source housing sections 13 with the heights of the corresponding locking holes 11a to 11c set to the same height.

Fall prevention fittings 4 are attached to outer wall surfaces of the outer frames 3 located at both the ends in the longitudinal direction of the equipment housing section 14. The fall prevention fittings 4 are caught by frame members of the ceiling, whereby the luminaire 1 is prevented from falling.

The light source module 12 is explained.

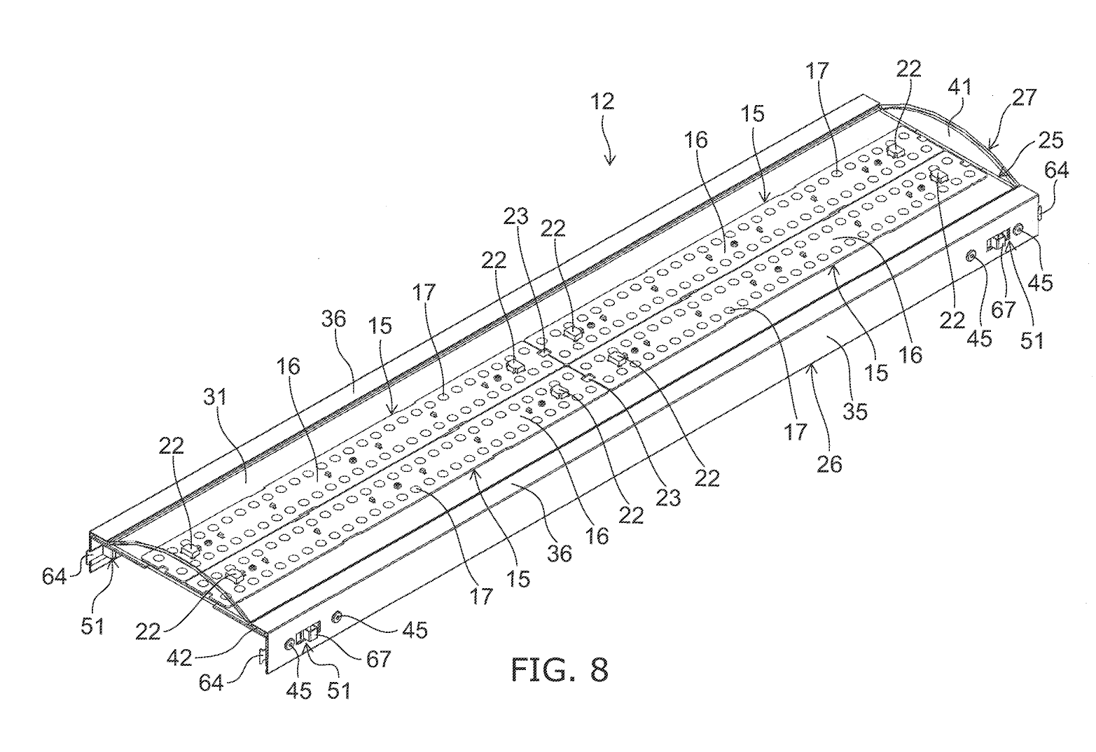

FIG. 8 is a perspective view of the light source module 12.

The light source module 12 includes light source units 15, a thermal radiation plate 25, a cover 27, and attaching members 26.

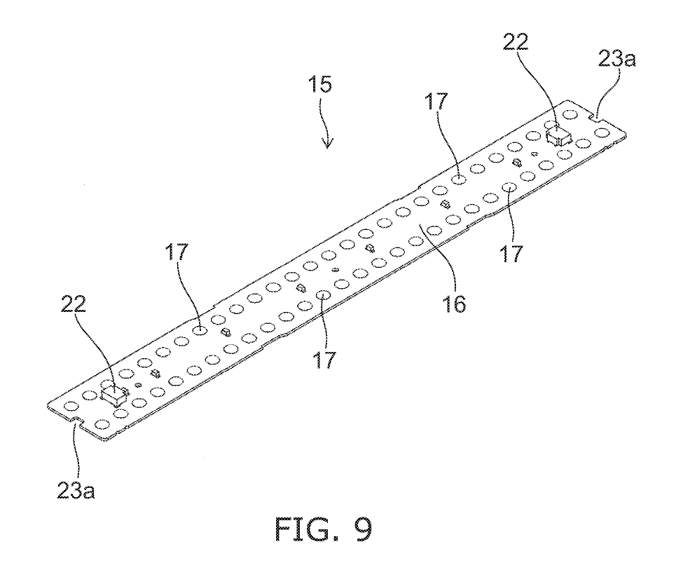

FIG. 9 is a perspective view of the light source unit 15.

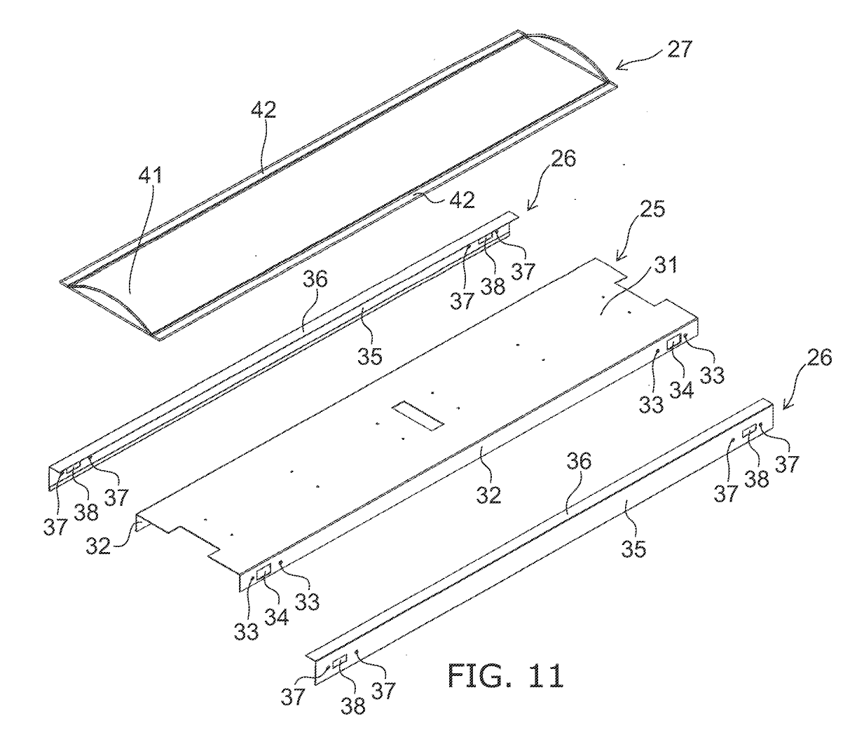

FIG. 11 is an exploded perspective view of the thermal radiation plate 25, the cover 27, and the attaching members 26.

The light source unit 15 includes, as shown in FIG. 9, a substrate 16 and a plurality of light-emitting elements 17 mounted on the substrate 16. A not-shown wire is formed on the substrate 16. The light-emitting elements 17 are electrically connected to the wire.

The light-emitting element 17 is, for example, a light emitting diode (LED). If, for example, gallium nitride (GaN) compound semiconductor is used as a material of an active layer of the LED, short wavelength light having wavelength equal to or smaller than 500 nanometers is obtained. However, the material of the active layer is not limited to the gallium nitride compound semiconductor.

As the light-emitting element 17, besides the LED, for example, an organic light emitting diode (OLED), an inorganic electroluminescence light-emitting element, an organic electroluminescence light-emitting element, or other light-emitting elements of a field emission type can be used.

In this embodiment, for example, an LED that emits blue light and a phosphor layer including a phosphor that absorbs the blue light (excitation light) and converts the blue light into yellow light are combined. Consequently, the light-emitting element 17 emits light having a white color, a bulb color, or the like as a mixed color of the blue light and the yellow light.

The substrate 16 is formed in an elongated bar shape. The plurality of light-emitting elements 17 are arrayed along the longitudinal direction in each of the vicinities of both the ends in the lateral direction (the width direction) of the substrate 16. Connectors 22 are mounted in the vicinities of both the ends in the longitudinal direction on the substrate 16. The connectors 22 are electrically connected to the light-emitting elements 17 through the wire.

As shown in FIG. 11, the thermal radiation plate 25 is a metal plate including a principal plane section 31 and a pair of side surface sections 32, which are integrally provided. The principal plane section 31 is formed in a substantially rectangular shape. Side surface sections 32 are integrally provided at both the ends in the lateral direction (the width direction) of the principal plane section 31. One surface (the upper surface in FIG. 11) of the principal plane section 31 is a light-source mounting surface. The side surface sections 32 extends in the longitudinal direction of the principal plane section 31 while projecting to the rear side of the light-source mounting surface.

As shown in FIG. 8, a plurality of (e.g., four in the figure) light source units 15 are mounted on the light-source mounting surface of the principal plane section 31. The substrate 16 of the light source unit 15 is, for example, screwed to the light-source mounting surface. The rear surface on the opposite side of the surface mounted with the light-emitting elements 17 in the substrate 16 is set in contact with the light-source mounting surface of the principal plane section 31. The substrate 16 of the light source unit 15 is, for example, a metal plate. Heat involved in light emission of the light-emitting elements 17 is efficiently conducted to the thermal radiation plate 25 through the substrate 16.

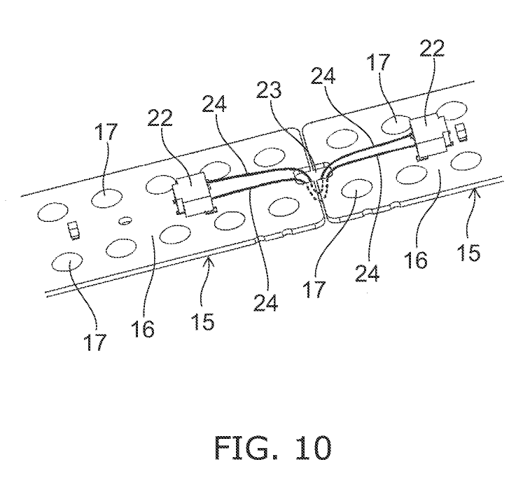

As shown in FIG. 9, cutouts 23a are formed in edge portions in the longitudinal direction of the substrate 16. In a state in which a plurality of substrates 16 are arranged in the longitudinal direction, the cutouts 23a of the substrate 16 are joined to the cutouts 23a of another substrate 16 to form a square opening 23 as shown in FIGS. 8 and 10.

As shown in FIG. 10, the two light source units 15 adjacent to each other in the longitudinal direction are electrically connected through an electric cable 24 connected between the connectors 22 of the light source units 15. A part of the electric cable 24 between both the connectors 22 is led out to the rear side of the substrate 16 through the opening 23 in a slacked state.

When the length of the electric cable 24 is adjusted to the distance between the connectors 22 to be connected, there is a concern that the length of the electric cable 24 is insufficient because of a dimensional tolerance and it may be difficult or impossible to connect the connectors 22. However, according to this embodiment, the length of the electric cable 24 is set longer than the distance between the connectors 22 to be connected and an excess portion of the electric cable 24 is led out to the rear side of the substrate 16 through the opening 23. Since the excess portion of the electric cable 24 does not stick out to the light-emitting surface side mounted with the light-emitting elements 17, light of the light-emitting surface is not blocked by the excess portion.

The cover 27 is mounted on the light-source mounting surface of the thermal radiation plate 25. A space above the light source unit 15 is covered with the cover 27. The cover is formed of, for example, a resin material having transparency to light emitted from the light-emitting elements 17.

The cover 27 includes a curved surface section 41 arranged in a convex shape on the light-source mounting surface and flange sections 42 (see FIG. 11) provided at both the ends in the lateral direction of the curved surface section 41 and extending in the longitudinal direction of the curved surface section 41.

The attaching members 26 are respectively attached to the pair of side surface sections 32 of the thermal radiation plate 25. The attaching member 26 is a metal member including a cover pressing section 36 and a side plate section 35 integrally provided perpendicularly to the cover pressing section 36. The cover pressing section 36 and the side plate section 35 extend in the longitudinal direction of the thermal radiation plate 25 and have a longitudinal direction size substantially the same as the longitudinal direction size of the thermal radiation plate 25.

The cover pressing section 36 is laid over the flange section 42 of the cover 27. The flange section 42 of the cover 27 is compressed between the principal plane section 31 of the thermal radiation plate 25 and the cover pressing section 36 of the attaching member 26. Consequently, the cover 27 is fixed to the thermal radiation plate 25.

At each of both the end portions in the longitudinal direction of the side surface section 32 of the thermal radiation plate 25, a pair of circular holes 33 and one rectangular opening 34 are formed to pierce through the side surface section 32. The pair of holes 33 is formed in positions on both sides of the opening 34 in the longitudinal direction.

At each of both the end portions in the longitudinal direction of the side plate section 35 of the attaching member 26, likewise, a pair of circular holes 37 and one rectangular opening 38 are formed to pierce through the side plate section 35. The pair of holes 37 is formed in positions on both side of the opening 38 in the longitudinal direction.

The side plate section 35 of the attaching member 26 is laid over the outer wall surface of the side surface section 32 of the thermal radiation plate 25. In this state, the holes 37 formed in the side plate section 35 are aligned with the holes 33 formed in the side surface section 32. Rivets 45 shown in FIG. 8 are inserted into and caulked in the holes 37 and 33, whereby the attaching member 26 is fixed to the thermal radiation plate 25.

In a state in which the side plate section 35 of the attaching member 26 is laid over the side surface section 32 of the thermal radiation plate 25, likewise, the openings 38 formed in the side plate section 35 are aligned with the openings 34 formed in the side surface section 32. As shown in FIG. 8, operation sections 67 of the fixtures 51 explained later are exposed through the openings 38 and 34.

The rivets 45 not only fix the attaching member 26 and the thermal radiation plate 25 but also have a function of attaching the fixtures 51 explained later to the inner wall surface of the side surface section 32 of the thermal radiation plate 25. That is, the thermal radiation plate 25, the fixtures 51, and the attaching member 26 are tightened together by the common rivets 45.

The fixture 51 is explained.

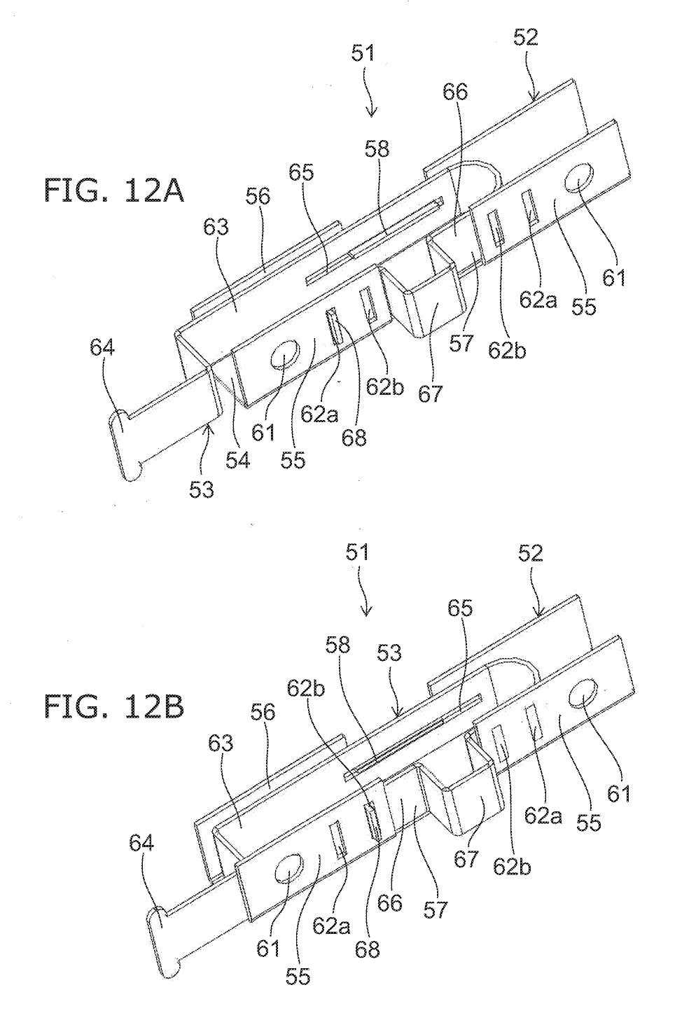

FIGS. 12A and 12B are enlarged perspective views of the fixture 51.

The fixture 51 includes a guide member 52 fixed to the light source module 12 and a movable member 53 configured to move between a retaining position and a releasing position explained below while being guided by the guide member 52.

FIG. 12A shows a state in which the movable member 53 is present in the retaining position (a retained state). FIG. 12B shows a state in which the movable member 53 is present in the releasing position (a released state).

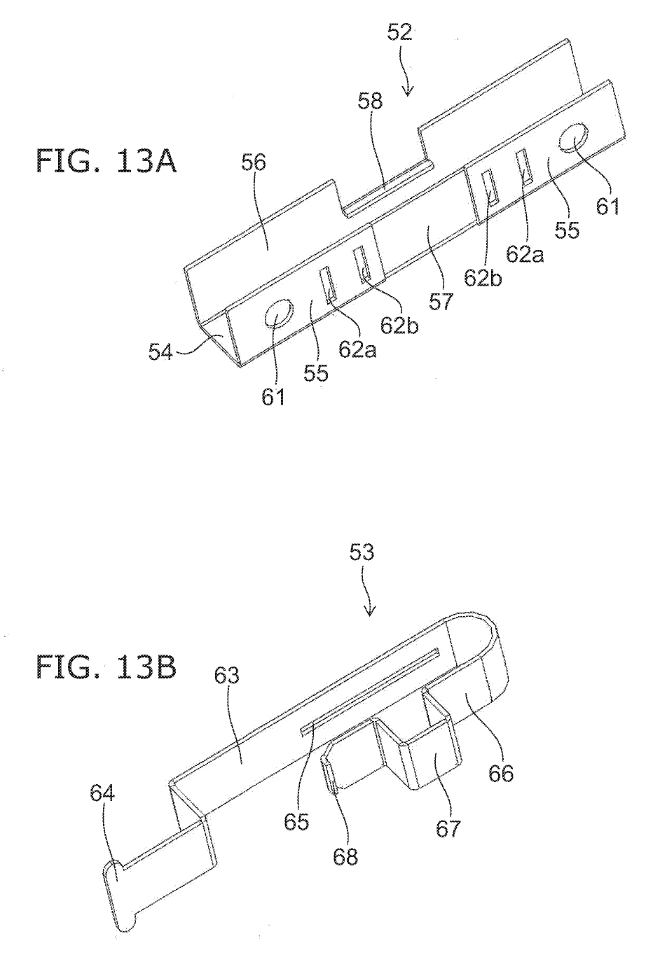

FIG. 13A is a perspective view of the guide member 52. FIG. 13B is a perspective view of the movable member 53.

The guide member 52 is formed of a metal material in which a rectangular plate-like base section 54 and a pair of side surface sections 55 and 56 perpendicular to the base sections 54 at both the ends in the lateral direction (the width direction) of the base section 54 are integrally provided.

An opening 57 is formed in the center in the longitudinal direction of one side surface section 55. One circular hole 61 and two slits 62a and 62b are formed in one of portions on both sides of the opening 57 in the longitudinal direction in the side surface section 55. Likewise, one circular hole 61 and two slits 62a and 62b are formed in the other of the portions on both the sides of the opening 57 in the longitudinal direction in the side surface section 55. The two slits 62a and 62b are formed between the hole 61 and the opening 57. The hole 61 and the slits 62a and 62b pierce through the side surface section 55.

In a center portion in the longitudinal direction in the side surface section 56 opposed to the side surface section 55 in parallel, a guide rib 58 projecting to the opening 57 side is integrally provided in the side surface section 56.

The movable member 53 is formed of a metal material in which a rectangular plate-like base section 63, a locking section 64, and a leaf spring section 66 are integrally provided.

In the base section 63, a guide groove 65 is formed along the longitudinal direction of the base section 63. The guide groove 65 pierces through the base section 63.

One end portion (the left end portion in FIG. 13B) in the longitudinal direction of the base section 63 extends in parallel to the base section 63 after bending to the near side on the paper surface in FIG. 13B perpendicularly to the base section 63. A T-shaped locking section 64 is provided further on the distal end side than the bending portion.

The leaf spring section 66 is folded back to be opposed to the guide groove 65 of the base section 63 while being cantilevered at the other end portion in the longitudinal direction of the base section 63 via a curved portion. In the leaf spring section 66, an operation section 67 projecting in a direction away from the base section 63 (to the near side on the paper surface in FIG. 13B) is integrally provided. Further, a lock section 68 projecting in the same direction as the operation section 67 is integrally provided at the distal end of the leaf spring section 66.

The leaf spring section 66 can swing (tilt) in a direction toward the base section 63 and a direction away from the base section 63 with the curved portion between the leaf spring section 66 and the base section 63 set as a fulcrum.

As shown in FIG. 12A, the guide rib 58 is inserted into the guide groove 65 and the operation section 67 is projected from the opening 57. In this state, the base section 63 of the movable member 53 is laid over the side surface section 56 of the guide member 52 and the leaf spring section 66 of the movable member 53 is laid over the side surface section 55 of the guide member 52.

An assembled state shown in FIG. 12A represents an assembled state in which, in a posture in which the base section 54 of the guide member 52 is set as the bottom surface and the side surface section 55 is faced to the near side on the paper surface, the locking section 64 is located further on the left side than the opening 57 and the lock section 68 is located in the side surface section 55 further on the left side than the opening 57. The movable member 53 in the fixture 51 attached to the end portion on the left side in the longitudinal direction of the light source module 12 shown in FIG. 8 is assembled to the guide member 52 in a direction shown in FIG. 12A.

In FIG. 12A, it is also possible to reverse the top and the bottom of the movable member 53 to reverse the left and right directions, locate the locking section 64 and the lock section 68 further on the right side than the opening 57, and assemble the movable member 53 to the guide member 52. The movable member 53 in the fixture 51 attached to the end portion on the right side in the longitudinal direction of the light source module 12 shown in FIG. 8 is assembled to the guide member 52 with the locking section 64 and the lock section 68 located further on the right side than the opening 57.

That is, irrespective of at which of the left and right end portions in the longitudinal direction of the light source module 12 the fixture 51 is attached, it is possible to project the locking section 64 from the end portion of the light source module 12 by changing the direction of attachment of the movable member 53 to the guide member 52 while using the guide member 52 and the movable member 53 common to both the sides.

Irrespective of in which direction the movable member 53 is attached, in the retained state in which an attached state of the light source module 12 to the main body 2 is retained, the lock section 68 is inserted into the slit (a first slit) 62a on a side close to the hole 61. In the released state in which the light source module 12 can separate from the main body 2, the lock section 68 is inserted into the slit (a second slit) 62b on a side close to the opening 57.

In a state in which the movable member 53 is assembled to the guide member 52, a space between the base section 63 of the movable member 53 and the leaf spring section 66 is slightly reduced from a natural state. The leaf spring section 66 is urged to the side surface section 55 side of the guide member 52 by a restoring force to the natural state. Therefore, in both the retained state and the released state, a state in which the lock section 68 is inserted in the slit 62a or 62b is maintained.

For example, in the retained state shown in FIG. 12A, when the operation section 67 is pushed to the base section 63 side, the lock section 68 comes out of the slit 62a and the movable member 53 can slide to the right. When the movable member 53 is moved to a position where the lock section 68 is opposed to the slit 62b on the opening 57 side and a pressing force on the operation section 67 is released, it is possible to insert the lock section 68 into the slit 62b as shown in FIG. 12B and maintain the released state.

In the released state, since the movable member 53 moves further to the right side than the retained state, projecting length of the locking section 64 from the left end of the guide member 52 is reduced. When the operation section 67 is pushed to the base section 63 side in the released state, the lock section 68 comes out of the slit 62b. The movable member 53 can be slid to the left to the retaining position shown in FIG. 12A.

The guide groove 65 of the movable member 53 relatively moves along the guide rib 58 of the guide member 52, which is a stationary body. Consequently, smooth and stable sliding of the movable member 53 is realized.

The baffle member 6 is explained.

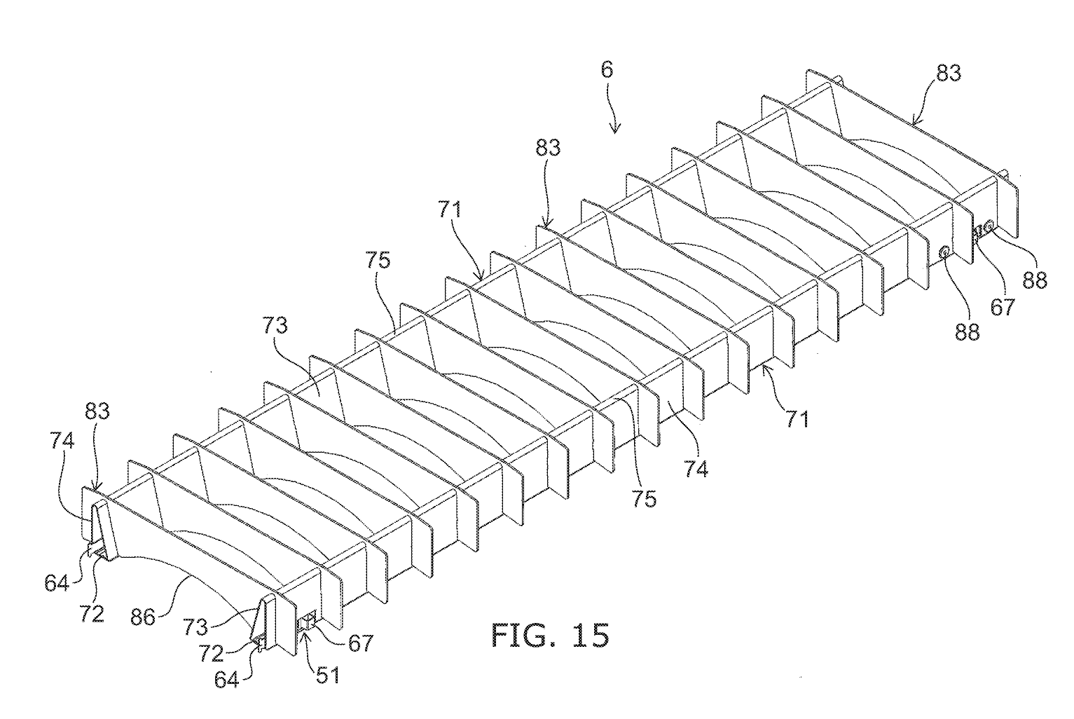

FIG. 15 is a perspective view of the baffle member 6.

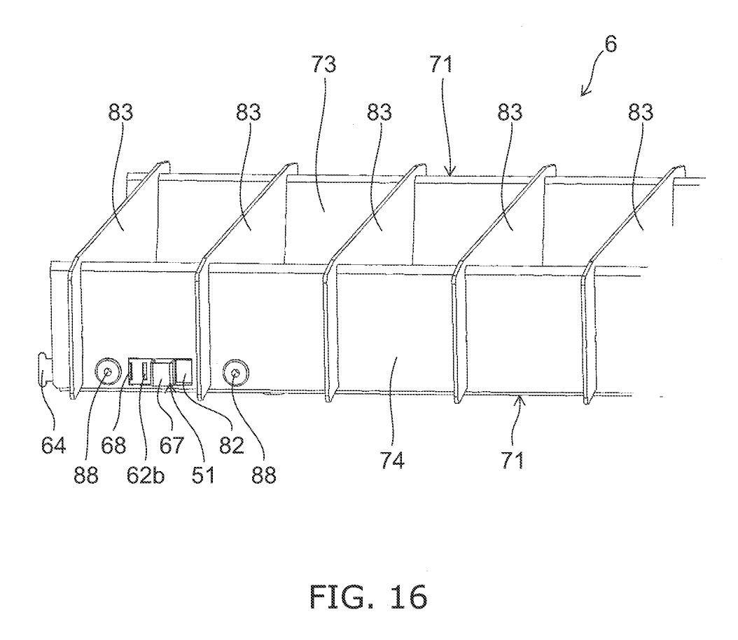

FIG. 16 is an enlarged perspective view of the end portion in the longitudinal direction of the baffle member 6.

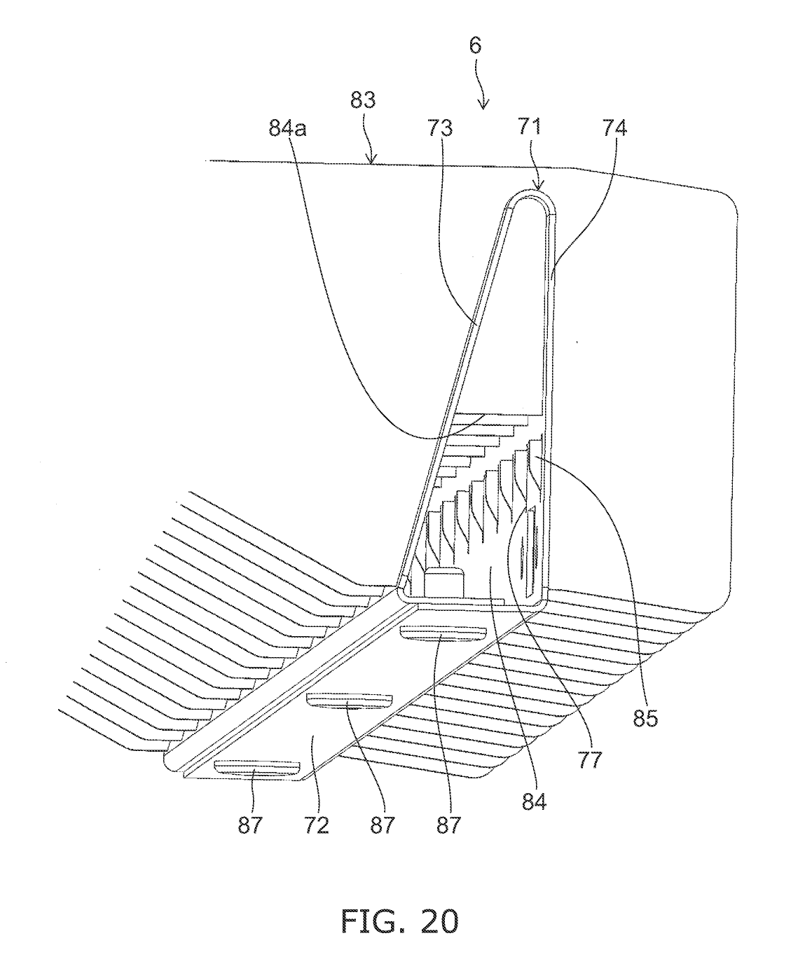

FIG. 20 is an enlarged perspective view of a baffle supporting section 71, which is one (on the right side in FIG. 15) of a pair of baffle supporting sections 71, viewed from the bottom surface side thereof.

The baffle member 6 includes the pair of baffle supporting sections 71 and a plurality of plate-like baffles supported by the baffle supporting sections 71. The plurality of baffles 83 are arranged spaced apart from one another in the longitudinal direction of the baffle supporting sections 71.

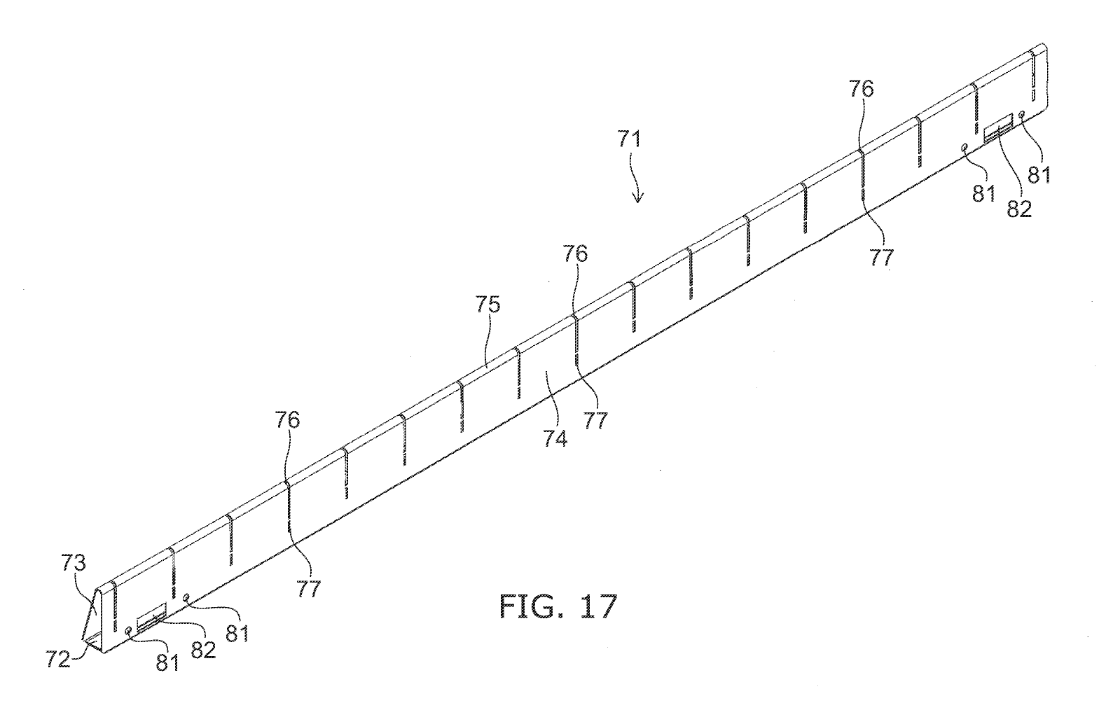

FIG. 17 is a perspective view of the baffle supporting section 71.

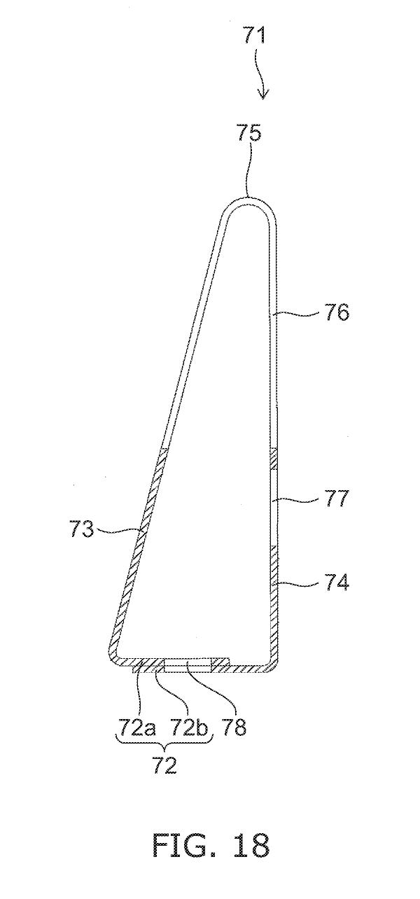

FIG. 18 is an enlarged sectional view of a portion where slits 76 and 77 are formed in the baffle supporting section 71.

By bending a metal plate (e.g., a steel plate), the baffle supporting section 71 is formed in a right angle triangular prism shape including a bottom surface section 72, a perpendicular side surface section 74 perpendicular to the bottom surface section 72, and an inclined side surface section 73 inclined with respect to the bottom surface section 72 and the perpendicular side surface section 74.

As shown in FIG. 18, the bottom surface section 72 is configured by overlaying both end portions 72a and 72b in the lateral direction (the width direction) of the metal plate to be machined into the baffle supporting section 71. Through-holes 78 are formed in the bottom surface section 72.

The bottom surface section 72 is formed in a rectangular plate shape. The perpendicular side surface section 74 is integrally provided at one end portion in the lateral direction (the width direction) of the bottom surface section 72. The inclined side surface section 73 is integrally provided at the other end portion. The perpendicular side surface section 74 and the inclined side surface section 73 are integrally connected via a curved top section 75.

A slit 76 is formed in nearly an upper half on the top section 75 side in the inclined side surface section 73 and the perpendicular side surface section 74. A plurality of slits 76 are formed at a predetermined interval in the longitudinal direction of the baffle supporting section 71.

A slit 77 having the same width as the slit 76 is formed right under each of the slits 76 on the bottom surface section side in the perpendicular side surface section 74. Therefore, a plurality of slits 77 are formed at the predetermined interval in the longitudinal direction of the baffle supporting section 71. The slit 77 is not connected to the slit 76 and does not reach the bottom surface section 72.

A pair of circular holes 81 and one rectangular opening are formed at each of both the end portions in the longitudinal direction of the perpendicular side surface section 74 while piercing through the perpendicular side surface section 74. The pair of holes 81 is formed in positions on both sides of the opening 82 in the longitudinal direction.

The width of a space on the inner side of the baffle supporting section 71 is narrowed from the bottom surface section 72 toward the top section 75.

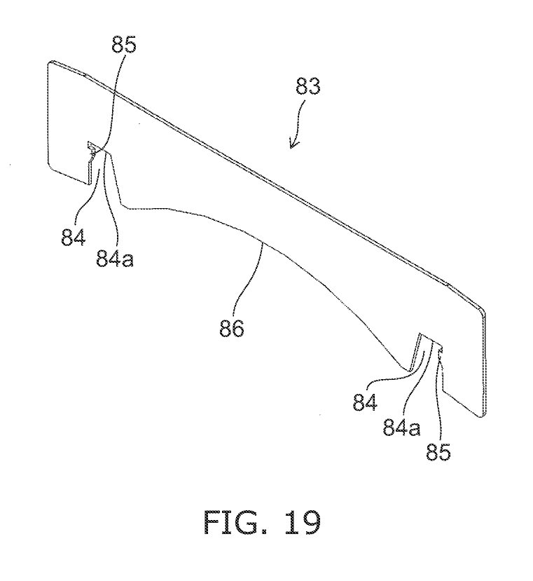

FIG. 19 is an enlarged perspective view of the baffle 83.

A pair of cutouts 84 is formed in the baffle 83. Claw sections 85 are respectively provided on the inner walls of the cutouts 84. The pair of cutouts 84 and the pair of claw sections 85 are formed symmetrically with respect to a center line that divides the longitudinal direction of the baffle 83 into two.

An end portion (a lower end portion in FIG. 19) on a side where the cutouts 84 are opened is faced to the light source module 12 side. A portion between the pair of cutouts 84 at the end portion is formed as a curved surface portion 86 extending along the curved surface section 41 of the cover 27 of the light source module 12.

As shown in FIG. 15, the pair of baffle supporting sections 71 is arranged in parallel with the inclined side surface sections 73 thereof opposed to each other. The pair of baffle supporting sections 71 is arranged in parallel with a distance corresponding to the distance between the pair of cutouts 84 formed in the baffle 83 apart from each other.

One cutout 84 of the baffle 83 is inserted into the slit 76 of one baffle supporting section 71. The other cutout 84 of the baffle 83 is inserted into the slit 76 of the other baffle supporting section 71. The baffle 83 is inserted to a position where an upper wall 84a of the cutout 84 comes into contact with the lower end of the slit 76.

In that state, as shown in FIG. 20, the claw sections 85 provided on the inner walls of the cutouts 84 are inserted into the slits 77 formed in the perpendicular side surface section 74. The upper ends of the claw sections 85 come into contact with the upper ends of the slits 77, whereby the baffle 83 is prevented from coming off the baffle supporting section 71.

Rivets 87 shown in FIG. 20 are inserted into and caulked in the through-holes 78 formed in the bottom surface section 72 of the baffle supporting section 71. Consequently, the movement of the inclined side surface section 73 and the perpendicular side surface section 74 in a direction in which an angle formed by the inclined side surface section 73 and the perpendicular side surface section 74 decreases is regulated. Therefore, the claw sections 85 do not come off the slits 77. It is possible to prevent the baffle 83 from separating from the baffle supporting sections 71.

The light source module 12 and the baffle member 6 are respectively detachably attached to the main body 2 via the fixtures 51.

As shown in FIG. 8, the fixture 51 is attached to the end portion in the longitudinal direction of the light source module 12. The fixture 51 is located on the inner side of the side surface section 32 of the thermal radiation plate 25. The holes 61 shown in FIG. 12A formed in the guide member 52 of the fixture 51 are aligned with the holes 33 formed in the side surface section 32 and the holes 37 formed in the side plate section 35 of the attaching member 26 laid over the side surface section 32 shown in FIG. 11. The rivets 45 are inserted into and caulked in the holes 37, 33, and 61. Consequently, the guide member 52 of the fixture 51 is fixed to the side plate section 35 of the light source module 12.

The operation section 67 of the movable member 53 of the fixture 51 projects to the outer side of the side plate section 35 from the opening 34 of the side surface section 32 and the opening 38 of the side plate section 35 laid over the side surface section 32 shown in FIG. 11. The operation section 67 is provided in the leaf spring section 66 as explained above. It is possible to slide the operation section 67 in the lateral direction (the longitudinal direction of the sideplate section 35) while pressing the operation section 67 against the inner side of the side plate section 35.

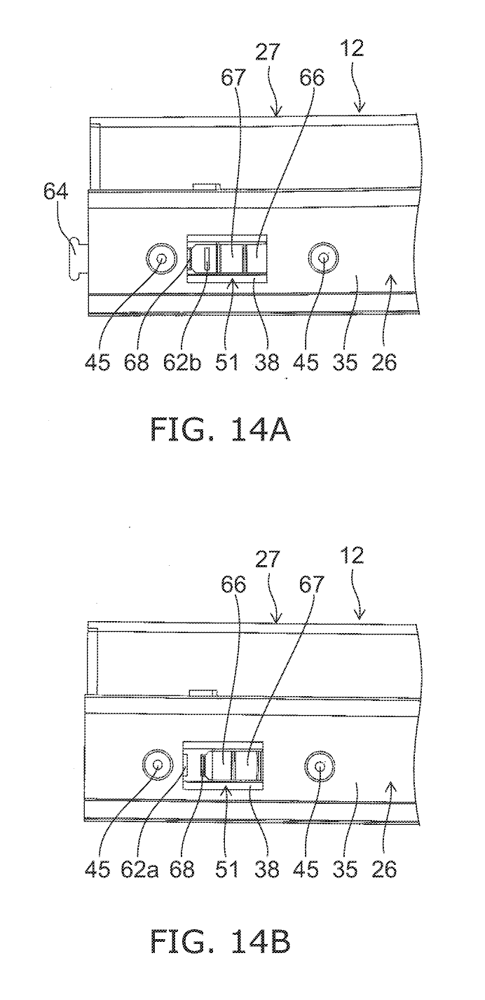

According to the slide of the operation section 67, the locking section 64 also slides in the lateral direction (the longitudinal direction of the side plate section 35). When the movable member 53 is present in the retaining position shown in FIGS. 12A and 14A, the locking section 64 projects from the end portion of the side plate section 35.

When the movable member 53 is located in the releasing position shown in FIGS. 12B and 14B, the projecting length of the locking section 64 from the end portion of the side plate section 35 is smaller than the projection length of the locking section 64 projecting from the end portion of the side plate section 35 when the movable member 53 is present in the retaining position. In an example shown in FIG. 14B, in the releasing position, the locking section 64 does not project from the end portion of the side plate section 35 and hides on the inner side of the side plate section 35. However, the projecting length of the locking section 64 only has to be relatively smaller in the releasing position than in the retaining position. The locking section 64 may slightly project from the end portion of the side plate section 35 in the releasing position.

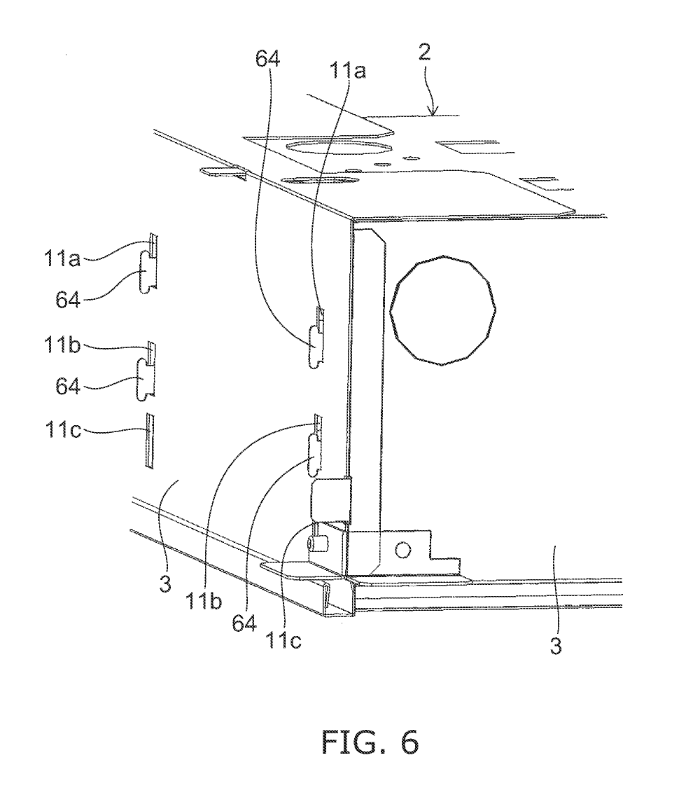

As shown in FIG. 3, the light source module 12 is housed in the light source housing section 13 of the main body 2 with the light-emitting surface mounted with the light-emitting elements 17 faced to the opposite side of the ceiling surface (the upper side in FIG. 3). In a state in which the light source module 12 is housed in the light-source housing section 13, the fixture 51 is present in the retaining position shown in FIGS. 12A and 14A. As shown in FIG. 6, the locking section 64 is locked in the locking hole 11b formed in the outer frame 3 of the main body 2. That is, the locking section 64 projects to the outer side of the outer frame 3 from the locking hole 11b and the lower end portion of the locking section 64 comes into contact with the lower end portion of the locking hole 11b, whereby the light source module 12 is prevented from coming off the main body 2.

When the fixture 51 is in the retaining position, as shown in FIG. 12A, the lock section 68 is inserted in the slit 62a. As explained above, the state in which the lock section 68 is inserted in the slit 62a is maintained by the urging force of the leaf spring section 66. Consequently, it is possible to prevent the movable member 53 from moving to the releasing position because of vibration, a shock, or the like. Therefore, it is possible to stably maintain a state in which the light source module 12 is attached to the main body 2.

As explained above, it is possible to pull out the lock section 68 from the slit 62a by pressing the operation section 67 and slide the movable member 53 to the releasing position shown in FIGS. 12B and 14B. In the releasing position, the locking section 64 comes out of the locking hole 11b. Therefore, it is possible to remove the light source module 12 from the main body 2.

Alternatively, when the light source module 12 is attached to the main body 2, the locking section 64 is retracted to the releasing position, whereby, since the locking section 64 does not hit the outer frame 2, it is possible to smoothly house the light source module 12 in the light source housing section 13. After the light source module 12 is housed in the light-source housing section 13, the operation section 67 is slid from the releasing position to the retaining position, whereby it is possible to hook the locking section 64 to the locking hole 11b.

As in the releasing position, as shown in FIG. 12B, it is possible to stably maintain, with the urging force of the leaf spring section 66, a state in which the lock section 68 is inserted in the slit 62b and stably perform attaching and detaching work. It is possible to pull the lock section 68 out of the slit 62b by pressing the operation section 67 and slide the locking section 64 to the retaining position.

As shown in FIG. 4, in a state in which the light source module 12 is housed in the light-source housing section 13, the side plate sections 35 of the light source module 12 are opposed to the inner walls of the outer frame 3 and the inner frame 7, which configure the light-source housing frame, across spaces 18 between the sideplate sections 35 and the inner walls of the outer frame 3 and the inner frame 7.

The operation sections 67 of the fixtures 51 project to be exposed in the spaces 18. The width of the spaces 18 is size enough for allowing a user to insert fingers into the spaces 18. The user can insert fingers into the spaces 18 to touch the operation sections 67 and slide the operation sections 67 in the lateral direction while pushing the operation sections 67 to the inner side of the side plate section 35. Alternatively, the user may operate the operation sections 67 using jigs rather than directly operating the operation sections 67 with the fingers. The spaces 18 function as intake ports of air conditioning equipment as well.

The operation sections 67 are exposed to sides of the side plate sections 35 projecting to the opposite side of the light-emitting surface in the light source module 12. The operation sections 67 do not shade the light-emitting surface and do not affect a luminous distribution characteristic. Since the operation sections 67 are present in positions hardly seen from the user, external appearance design is not spoiled.

As shown in FIG. 2, the baffle member 6 is housed on the light-emitting surface side of the light source module 12 in the light-source housing section 13. Therefore, when the user present in a lower space other than a space right below the luminaire 1 looks up the luminaire 1 from a specific angle, the light-emitting surface is blocked by the baffles 83 and the user does not directly view the light-emitting surface. Therefore, it is possible to reduce dazzling feeling.

As shown in FIGS. 15 and 16, the fixture 51 having the same configuration as the fixture 51 attached to the light source module 12 is attached to the baffle member 6 as well.

The fixture 51 is attached to the end portion in the longitudinal direction of the baffle supporting section 71.

The fixture 51 is arranged in a space surrounded by the bottom surface section 72, the perpendicular side surface section 74, and the inclined side surface section 73 in the baffle supporting section 71.

The holes 61 shown in FIG. 12A formed in the guide member 52 of the fixture 51 are aligned with the holes 81 formed in the perpendicular side surface section 74 shown in FIG. 17. Rivets 88 shown in FIG. 16 are inserted into and caulked in the holes 81 and 61. Consequently, the guide member 52 of the fixture 51 is fixed to the perpendicular side surface section 74 of the baffle supporting section 71.

As in the light source module 12, in a state in which the baffle member 6 is housed in the light-source housing section 13, the fixture 51 is present in the retaining position shown in FIG. 12A. In the retained state, as shown in FIG. 6, the locking section 64 of the fixture 51 attached to the baffle member 6 is locked in the locking hole 11a formed in the outer frame 3 of the main body 2. That is, the locking section 64 projects to the outer side of the outer frame 3 from the locking hole 11a and the lower end portion of the locking section 64 comes into contact with the lower end portion of the locking hole 11a, whereby the baffle member 6 is prevented from coming off the main body 2.

As in the light source module 12, since the state in which the lock section 68 is inserted in the slit 62a is maintained by the urging force of the leaf spring section 66, it is possible to prevent the movable member 53 from moving to the releasing position because of vibration, a shock, or the like. Therefore, it is possible to stably maintain a state in which the baffle member 6 is attached to the main body 2.

It is possible to pull out the lock section 68 from the slit 62a by pressing the operation section 67 and slide the movable member 53 to the releasing position shown in FIG. 12B. In the releasing position, the locking section 64 comes out of the locking hole 11a. Therefore, it is possible to remove the baffle member 6 from the main body 2.

Alternatively, when the baffle member 6 is attached to the main body 2, the locking section 64 is retracted to the releasing position, whereby, since the locking section 64 does not hit the outer frame 2, it is possible to smoothly house the baffle member 6 in the light source housing section 13. After the baffle member 6 is housed in the light-source housing section 13, the operation section 67 is slid from the releasing position to the retaining position, whereby it is possible to hook the locking section 64 to the locking hole 11a.

The operation section 67 projects to the outer side of the perpendicular side surface section 74 from the opening 82 formed in the perpendicular side surface section 74 of the baffle supporting section 71 shown in FIG. 17. As shown in FIGS. 15 and 16, both the end portions of the baffles 83 project further to the outer sides (the outer sides of the perpendicular side surface sections 74) than the baffle supporting sections 71. The operation section 67 is exposed between projecting portions of the baffles 83.

Since the end portions of the baffles 83 further project than the perpendicular side surface section 74, in a state in which the baffle member 6 is housed in the light-source housing section 13, spaces are formed between the perpendicular side surface section 74 and the outer frame 3 and between the perpendicular side surface section 74 and the inner frame 7. The user can insert fingers in spaces further partitioned by the end portions of the baffles 83 to operate the operation sections 67. Alternatively, the user may operate the operation sections 67 using a jig rather than directly operating the operation sections 67 with the fingers.

In the luminaire 1 according to the embodiment explained above, the light source module 12 and the baffle member 6 are detachably attached to the main body 2 via the fixtures 51. Therefore, it is possible to easily attach the light source module 12 and the baffle member 6 to and detach the light source module 12 and the baffle member 6 from the main body 2 by operating the operation section 67.

As shown in FIG. 6, the plurality of locking holes 11a to 11c are formed in positions at different heights in the outer frame 3. It is possible to change attaching heights of the light source module 12 and the baffle member 6 in the light-source housing section 13 by selecting the locking holes 11a to 11c in which the locking sections 64 are locked.

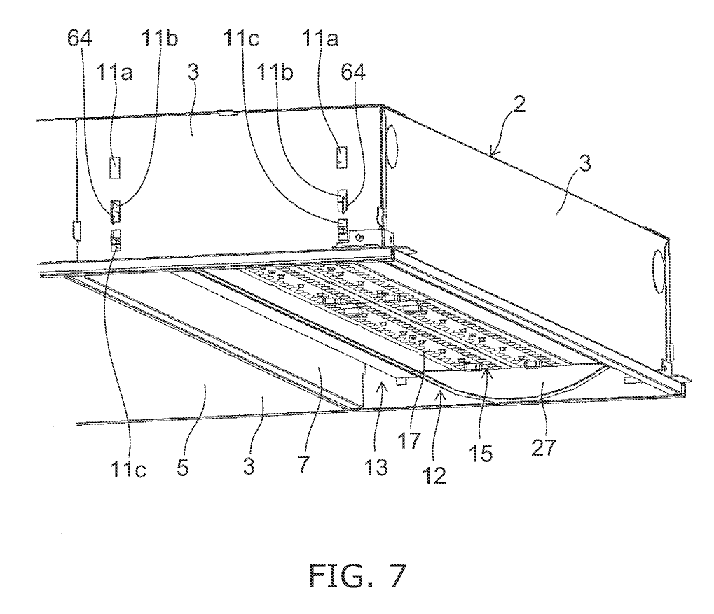

For example, it is also possible not to attach the baffle member 6 according to a request of the user. In this case, as shown in FIG. 7, the locking sections 64 of the fixtures 51 attached to the light source module 12 are locked in the locking holes 11b formed in positions at middle height among three pairs of locking holes 11a to 11c. Consequently, it is possible to set the light-emitting surface closer to the lower side (an illumination target space side) compared with the case in which the locking sections 64 are locked in the locking holes 11a on the ceiling side. Alternatively, the locking sections 64 of the light source module 12 may be locked in the locking holes 11c most distant from the ceiling.

When the baffle member 6 is attached, as in the embodiment explained with reference to FIGS. 1, 2, and 6, the locking sections 64 of the light source module 12 are locked in the locking holes 11a on the ceiling side and the locking sections 64 of the baffle member 6 are locked in the locking holes 11b below the locking holes 11a. Consequently, it is possible to prevent deterioration in an optical characteristic and appearance due to large projection of the baffle member 6 to the lower surface side of the main body 2.

The light source module 12 and the baffle member 6 can be attached to and detached from the main body 2 using the fixtures 51, which are the same common components. Therefore, when the light source module 12 is attached to the main body 2 and when the baffle member 6 is attached to the main body 2, the operation of the fixtures 51 is the same. Therefore, it is possible to improve workability of an installer. Further, it is possible to realize a reduction in costs through use of common components.

FIG. 5 shows an arrangement relation between the light source module 12 and the baffle member 6 in the light-source housing section 13.

A power supply unit (or a control unit) 21 that supplies electric power to the light-emitting elements 17 and controls lighting of the light-emitting elements 17 is arranged on the rear side (the ceiling side) of the light source module 12.

The baffle supporting sections 71 of the baffle member 6 and the fixtures 51 arranged in the internal spaces of the baffle supporting sections 71 are located further on the outer side in the lateral direction than the light-emitting surface mounted with the light source unit 15 in the light source module 12. Therefore, the baffle supporting sections 71 and the fixtures 51 do not obstruct light emitted from the light-emitting surface.

Viewed from the user present on the upper side in FIG. 5, the fixtures 51 of the baffle member 6 hide on the inside of the baffle supporting sections 71 and the fixtures 51 of the light source module 12 hide on the rear side further on the outer side in the lateral direction than the light-emitting surface. Therefore, the fixtures 51 are not seen from the user and do not spoil appearance design characteristics.

In FIG. 5, in side portions in a space above the light-emitting surface (below the ceiling), the inclined side surface sections 73 of the baffle supporting sections 71 extend along the longitudinal direction of the light source module (the direction piercing through the paper surface). Consequently, it is possible to realize luminous intensity distribution spreading from the light-emitting surface side to a space where the user is present.

A space 46 is formed between the curved surface section 86 at the end portion on the light source module 12 side of the baffle 83 and the curved surface section 41 of the cover 27 of the light source module 12. The baffle 83 is not in contact with the cover 27. Therefore, it is possible to prevent damage to the cover 27.

The curved surface section 86 of the baffle 83 is formed in a shape matching the curved surface section 41 of the cover 27, whereby it is possible to set the height of the space 46 between the curved surface sections 86 and 41 uniform. Consequently, a luminous intensity distribution characteristic controlled by the shape of the curved surface section 41 of the cover 27 is not spoiled by the presence of the space 46.

As a comparative example, the structure of a baffle member is conceivable in which plural places in one sheet metal are bent to erect baffles and supporting sections and the baffles are integrally provided. However, this causes an increase in weight.

On the other hand, according to the embodiment, the baffle supporting sections 71 and the baffles 83, which are separate bodies, are combined to form the baffle member 6. It is possible to realize a reduction weight by forming the baffles from, for example, aluminum while forming the baffle supporting sections 71 from, for example, a steel plate to secure strength.

In a state in which the light source module 12 is attached to the main body 2, only the surfaces on the outer sides of the inclined side surface 73 and the perpendicular side surface section 74 in the baffle supporting section 71 having a cylindrical shape can be seen from the user. The surfaces on the inner side (the inner wall surfaces of the internal space) cannot be seen. Therefore, in the sheet metal before being bent and machined into the baffle supporting section 71, only one surface to be formed as the surface on the outer side is painted (e.g., painted in white) and the other surface to be formed as the surface on the inner side does not have to be painted. Consequently, it is possible to realize a reduction in costs through a reduction in painting expenses without spoiling appearance design characteristics.

By changing a pitch in the longitudinal direction of the plurality of slits 76 formed in the baffle supporting section 71, it is possible to change a pitch between the baffles 83 inserted into the slits 76 and easily perform control of a light blocking angle. Further, common components having the same structure can be used as the plurality of baffles 83.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A luminaire comprising:
a main body including a light-source housing frame;
a light source module provided on the inner side of the light-source housing frame and including a substrate and a plurality of light-emitting elements mounted on the substrate; and
a fixture attached to the light source module, the fixture including a locking section movable between a retaining position where the locking section projects from an end portion of the light source module and locks to the light-source housing frame to retain the light source module in the main body, and a releasing position where the locking section is unlocked from the light-source housing frame to enable the light source module to separate from the main body.

2. The luminaire according to claim 1, wherein
the light-source housing frame includes a plurality of locking holes formed in positions at different heights, the locking section being capable of locking in the locking holes, and
the locking hole in which the locking section is locked is selected to change attaching height of the light source module in the light-source housing frame.

3. The luminaire according to claim 1, wherein the fixture includes a leaf spring section, and the retaining position of the locking section is maintained by an urging force of the leaf spring section.

4. The luminaire according to claim 1, wherein the light source module includes a side plate section projecting to a rear surface side on an opposite side of a mounting surface of the light-emitting elements in the substrate.

5. The luminaire according to claim 4, wherein the side plate section of the light source module is opposed to an inner wall of the light-source housing frame across a space between the side plate section and the inner wall.

6. The luminaire according to claim 5, wherein the fixture includes an operation section attached to the side plate section to be capable of sliding integrally with the locking section while projecting to the space.

7. The luminaire according to claim 1, wherein the fixture includes:
a guide member fixed to the light source module; and
a movable member configured to move between the remaining position and the releasing position while being guided by the guide member, the locking section being provided in the movable member.

8. The luminaire according to claim 7, wherein
the guide member includes a first slit, and
the movable member includes a lock section inserted into the first slit in the retaining position.

9. The luminaire according to claim 8, wherein the movable member includes:
a leaf spring section; and
an operation section configured to elastically deform the leaf spring section and move the lock section in a direction for urging the lock section to the first slit and a direction for moving the lock section away from the first slit.

10. The luminaire according to claim 8, wherein
the guide member further includes a second slit formed side by side with the first slit in a moving direction of the movable member, and
the lock section of the movable member is inserted into the second slit in the releasing position.

11. The luminaire according to claim 1, further comprising a baffle member provided on a light-emitting surface side of the light source module on the inner side of the light-source housing frame, wherein
the baffle member includes:
a baffle supporting section including a plurality of slits; and
a plurality of plate-like baffles inserted into the slits of the baffle supporting section and arranged spaced apart from one another in a longitudinal direction of the light source module.

12. The luminaire according to claim 11, wherein
a fixture having same structure as the fixture attached to the light source module is attached to the baffle member, and
the baffle member is also detachably attachable to the main body by moving operation of the locking section of the fixture.

13. The luminaire according to claim 12, wherein the fixture includes:
a guide member fixed to the baffle supporting section; and
a movable member configured to move, while being guided by the guiding member, between a retaining position where the movable member retains the baffle member in the main body and a releasing position where the movable member enables the baffle member to separate from the main body, the locking section being provided in the movable member.

14. The luminaire according to claim 13, wherein
the baffle supporting section is formed in a cylindrical shape by bending of a sheet metal, and
the guide section is arranged on an inner side of the cylindrical baffle supporting section.

15. The luminaire according to claim 14, wherein a surface on an outer side of the cylindrical baffle supporting section is painted and a surface on the inner side of the cylindrical baffle supporting section is not painted.
